(19) United States
(12) Patent Application Publication
(10) Pub. No.: US 2023/0241826 A1
(43) Pub. Date: Aug. 3, 2023

(54) METHOD AND DEVICE FOR REDUCING THE AMOUNT OF REWORKING REQUIRED ON MOLD CAVITIES PRIOR TO THEIR USE IN SERIES PRODUCTION

(71) Applicant: Röchling Automotive SE & Co. KG, Mannheim (DE)

(72) Inventor: Thomas Tsigkopoulos, Nürnberg (DE)

(21) Appl. No.: 18/102,529

(22) Filed: Jan. 27, 2023

(30) Foreign Application Priority Data
Feb. 2, 2022 (DE) 10 2022 102 395.8

(51) Int. Cl. B29C 45/76; B29C 45/80

(52) U.S. Cl. CPC B29C 45/7693; B29C 45/7646; B29C 45/80; B29C 2945/76127; B29C 2945/76046; B29C 2945/7605; B29C 2945/76103; B29C 2945/76254; B29C 2945/76297; B29C 2945/76006; B29C 2945/76585

(57) ABSTRACT

A method for determining optimized shape data representing a shape of a molded workpiece formed from a molded material or/and a mold cavity of a molding tool, wherein the molded material hardens depending on at least one solidification parameter, the method including:
a) providing shape data representing a shape of the workpiece or/and cavity,
b) providing material data representing the molded material,
c) providing molding process data representing the molding process,
d) providing tool data representing the tool embodying the cavity,
e) determining predictive shape data based on initial model data comprising the at least one solidification parameter and data provided in steps a), b), c), and d) simulating the molding process,
f) generating optimized predictive shape data as the optimized shape data based on at least predictive shape data determined in step e) and based on first initial AI data comprising the at least one solidification parameter and data provided in steps a, b), c), and d), by means of an artificial neural simulation optimization network trained to optimize predictive shape data.

This application claims priority in German Patent Application DE 10 2022 102 395.8 filed on Feb. 2, 2022, which is incorporated by reference herein.

The present invention relates to a method for determining optimized shape data which represent a shape of a molded workpiece or/and a shape of a mold cavity of a molding tool, the molded workpiece being formed from a molded material which is introduced in a flowable manner into the mold cavity as part of the molding shaping process, the molded material hardening as a function of at least one solidification parameter.

### BACKGROUND OF THE INVENTION

As a rule, molded workpieces undergo a change in shape after demolding from the mold cavity due to their solidification from a flowable state, irrespective of the specific molding process. Frequently, the molded workpieces harden by cooling or cool at least during their hardening, whereby a dimensional change induced thermally or thermo-mechanically or thermochemically is usually added to a change in shape due to the change in the aggregate state. In the present application, the terms “solidify” and “harden” are used synonymously.

In principle, hardening can take place by chemical crosslinking processes within an initially flowable molded material, as is known, for example, from silicone polymers. For the initiation of chemical crosslinking processes, heating of the molded material above an excitation temperature threshold may be required, whereby the molded material in turn cools back down from the temperature level above the excitation temperature threshold to ambient or room temperature.

The more common case of hardening is that of thermal solidification, in which the molded material solidifies by cooling the initially flowable molded material. In the case of amorphous molded materials, their viscosity decreases with their temperature until the amorphous molded material is a highly viscous quasi-solid. In the case of crystalline molded materials, crystallization of the material, i.e. the arrangement of previously freely movable molecules in a defined lattice structure, sets in as soon as the temperature falls below the melting point or crystallization temperature, which also turns the molded object into a solid. In the case of partially crystalline molded materials, both amorphous and crystalline solidification mechanisms take place. The totality of all shape changes occurring during the hardening of a molded material will be referred to in the following as “shrinkage”, irrespective of whether this is caused by thermal expansion or contraction or/and by reorientation of molecules between free mobility and arrangement in lattice structures or by still further processes, such as reorientation of fillers.

During the initial molding process, the flowable molded material first fills the mold cavity, which transfers its positive shape onto the molded material in the form of a negative shape. Once the molded material has hardened sufficiently in the mold cavity, the mold cavity can be opened and the molded workpiece removed from the mold. As a result of temperature equalization and/or pressure equalization and/or stress equalization and/or reaction processes in the workpiece, which continue to take place in particular after demolding, the workpiece changes its shape as a result of transient, generally heterogeneous and/or anisotropic distortion processes of thermal length change and/or generally negative thermal expansion, depending on the molded material used for its production, compared with the shape present at demolding.

In order to avoid having to rework workpieces that have been produced by molding, or in order to avoid having to discard workpieces that cannot be reworked due to their nature, manufacturers try to produce workpieces by molding in such a way that, after complete cooling to room temperature and/or after completion of all relaxation processes in the workpiece at room temperature, they deviate from their nominal shape assigned by their design only within specified tolerance limits.

In order to guide a molding process, taking into account the shrinkage that occurs during hardening, in such a way that at the end of the process the shape of the workpiece is within specified tolerance limits around the nominal shape, manufacturers have attempted to simulate the molding process on the basis of numerical models of the process. However, this often does not lead to the desired result because the real process to be modeled is exceedingly complex. The complexity is due to the sequence of transient, strongly nonlinear, often multiphase and even anisotropic heat transfer, mass transfer and hardening processes. Particularly when molded materials are processed with admixtures of non-flowable material, the complexity increases considerably, since to date it has not been possible to model the influence of the admixtures on the above-mentioned processes with sufficient accuracy.

The complexity of a molding process to be modeled can be illustrated by the following simplified relationships: for example, the flow processes of the molded material in the mold cavity determine when and to what extent molded material in the cavity comes into contact with a cavity wall. Such contact changes the situation of heat transfer from the molded material to its surroundings, which in turn changes the flowability of the molded material, which affects further flow processes, etc. In case of a contact of the molded material with the cavity wall, heat transfer usually takes place from the molded material to the material of the molding tool, which locally changes the temperature of the molding tool, so that the temperature difference between the molded material and the molding tool changes, which in turn changes the amount of heat transferred per unit time between the molded material and the mold, which eventually modifies the temporal cooling profile of the molded material.

The complexity of the process to be simulated is further increased by the dependencies of numerous material values influencing the molding process, such as density, heat capacity, thermal conductivity, in particular as a thermal conductivity tensor, viscosity, in particular as a viscosity tensor, and stiffness, in particular as a stiffness tensor, to name just five examples, on other changing physical variables of the respective material, such as temperature and/or pressure, and/or on their time gradients and/or the temporal temperature and pressure change.

Every model which represents a real process in a simplified way is inevitably subject to errors and introduces inaccuracies into the simulation process. In the present case of a superimposed fluid-mechanical and thermo-mechanical and often even thermochemical simulation, the inaccuracies of the model are considerable. Inaccuracies of the applied numerical methods are added to these. Commercially available simulation products such as Moldflow®, Moldex3D® or Cadmould® offer a model-based simulation of molding processes, in particular the preferred injection molding, injection-compression molding and compression molding processes, but do not achieve the desired accuracy in predicting the final shape of shrinkage-affected molded workpieces. Comparisons of simulation results with actually produced molded workpieces show that the final shape of the molded workpiece is predicted correctly by simulation only in some regions, while in other regions the error between the predicted and the actually obtained dimension is in the double-digit or even triple-digit percentage range or is even predicted incorrectly in terms of quality, i.e. a region predicted to be convexly deformed actually turns out to be concavely deformed and vice versa.

As a result, the workpiece shape actually obtained during a molding process with a specific molding tool cannot be predicted with sufficient accuracy by simulation, which leads to the necessity of trial and error when introducing a molding tool for the production of a new molded workpiece: the molding process or/and the molding tool are iteratively modified on the basis of the molded workpieces actually obtained with it until a molded workpiece is finally obtained which deviates sufficiently little from its nominal dimensions. This “tuning” effort for molding processes and especially for molding tools is as considerable as it is undesirable.

### SUMMARY OF THE INVENTION

It is therefore the object of the present invention to increase the prediction accuracy concerning the shape of a workpiece to be produced by means of a mold and thus to reduce the amount of iterative post-processing of the molding tool used to produce the molded workpiece and, in particular, of its mold cavity.

This object is achieved according to a method aspect of the present invention in that the method mentioned comprises the following steps:

a) providing initial shape data representing an initial shape of a workpiece to be molded and/or of an initial cavity to be used for molding the workpiece,

b) providing material data representing the molded material,

c) providing molding process data representing the molding process,

d) providing tool data representing information about the tool embodying the mold cavity beyond the initial shape of the mold cavity,

e) determining predictive shape data representing an expected shape of the molded workpiece after the molding process on the basis of initial model data comprising the at least one solidification parameter and initial shape data, material data, molding process data and tool data provided in steps a), b), c), and d) by means of an electronic data processing system by simulating the molding process,

f) generating optimized prediction shape data representing a shape of the molded workpiece expected after the molding process with higher prediction accuracy than in step e) as the optimized shape data on the basis of at least prediction shape data determined in step e) and on the basis of first initial AI data, which comprises the at least one solidification parameter and initial shape data, material data, molding process data and tool data provided in steps a), b), c) and d), by means of an electronic data processing system, wherein the electronic data processing system is designed as an artificial neural simulation optimization network trained to optimize prediction shape data.

The initial shape data represent the initial shape of the workpiece to be produced with its nominal dimensions according to its design. The initial shape data additionally or alternatively represent the initial shape of the initial cavity with which the workpiece to be molded (molded workpiece) is to be manufactured. Due to shrinkage dimensions already taken into account at the initial cavity, the initial cavity is usually not necessarily just a direct negative image of the workpiece to be produced therewith. However, it can be sufficient to initially consider only the molded workpiece or only the mold cavity and to determine the other shape based on optimized shape data obtained for the one shape of the workpiece or cavity.

The initial shape data can be any data that describe the initial shape with sufficient precision. The initial shape data can thus comprise point clouds and/or two- or three-dimensional shape regions, such as edge lines and/or surface regions, their orientations and angles enclosed between the two- or three-dimensional regions. Preferably, the initial shape data are CAD data resulting from the design.

The material data represent the molded material. They usually comprise physical quantities of the molded material and their values, which are important for the respective molding process. The abstraction that is usually acceptable or even desirable in the representation of real processes by parametric description allows a selection of material parameters that are considered to be particularly relevant and their use as material data.

In addition to the material data, the type of molding process and its process control also influence the resulting workpiece, which is why molding process data is provided. What has been said about the abstraction of material data also applies to the molding process data. Not every datum of the molding process has to be taken into account in the present procedure.

In principle, the method presented here can be used for any molding process. Preferably, the present method is to be applied as a molding process to the case of injection molding processes because of their high industrial relevance. However, it should not be excluded that the present method may be applied to other molding processes, such as conventional casting, die casting, pressing, injection compression molding and the like.

Likewise, the molding process is significantly influenced by the mold tool used, which is why data about the mold tool must also be provided. The initial cavity, which is embodied on the molding tool, is already represented by the initial shape data. However, the mold extends beyond the initial cavity, for example by choice of tool material, tool size, tool tempering, number, shape, type and spatial arrangement of sprues, tempering channels and the like. What has been said above about the abstraction of data also applies to tool data.

The provided initial shape data, material data, molding process data, and tool data constitute initial data for a simulation of the molding process by an electronic data processing system. Since the simulation is usually a model-based simulation, the initial data used for the simulation is referred to as “initial model data” in the present application to distinguish possible other initial data. However, the term “initial model data” is only intended to clarify a linguistic assignment of the initial data to the process simulation. An obligatory content-wise demarcation to other initial data is not meant hereby.

Additionally, the at least one solidification parameter guiding the solidification or hardening of the molded material is part of the initial model data. In many cases, the at least one solidification parameter will include the temperature of the molded material when the molded material solidifies by thermal cooling, as is most often the case.

The at least one solidification parameter may also include the temperature of the molded material if the molded material hardens by chemical crosslinking, but the onset or/and progression of chemical crosslinking is in some way temperature dependent.

If crystallization occurs during solidification, a parameter describing the crystallization can also be a solidification parameter.

The result of the simulation of the molding process is the prediction shape data as explained at the beginning in the description of the task on which the present invention is based. By means of the simulation, e.g. using one of the commercially available simulation program products mentioned above, prediction shape data are obtained which represent the shape of the molded workpiece produced by the modeled molding process expected on the basis of the simulation model used, but whose accuracy is at least uncertain.

By means of an appropriately trained artificial neural network, optimized prediction shape data can be generated from the prediction shape data, which predict with considerably higher accuracy the expected shape of the workpiece to be produced with the considered molding process.

Since the planned molding process is also the working basis for the neural network, the artificial neural network generates the optimized prediction shape data, on the one hand, on the basis of the prediction shape data determined by the simulation of the molding process as input data and, on the other hand, on the basis of initial data which comprise the above-mentioned provided initial shape data, material data, molding process data and tool data as well as the at least one solidification parameter. In order to differentiate such initial data used by the artificial neural network from initial data used by the simulation, the initial data of the artificial neural network is referred to as “initial AI data” in the present application. Again, this term merely denotes an assignment of initial data to a data processing instance and not a necessary difference in content compared to initial data of other data processing instances, such as the aforementioned simulation.

The artificial neural network can be trained, for example, on the basis of already existing prediction shape data for molded workpieces and/or cavities used for this purpose as well as actual shape data of real molded workpieces and/or mold cavities assigned to these, i.e. for such molded workpieces which can be or were actually produced by a defined molding process within predefined tolerance limits with sufficiently precise dimensions or for such mold cavities which permit a production of real molded workpieces in a defined molding process within predefined tolerance limits. Furthermore, for training the artificial neural network, shape data can be used which are obtained during a cooling phase of the real molded workpiece after demolding at predetermined time intervals by shape detection, for example by scanning, of the molded workpiece. In addition, the real molded workpiece can be thermographically recorded during its cooling phase and information about its actual surface temperature distribution can thus be obtained. The thermographic acquisition of the molded workpiece can be correlated in time with its shape detection, so that information about the shape of the molded workpiece and its surface temperature distribution can be obtained for one or more narrow time periods during the cooling phase of the real molded workpiece. The surface temperature data of the real molded workpiece can also be used when training the artificial neural network.

The training can be a continuous or continuously recurring process, in which prediction shape data of molded workpieces are repeatedly linked to shape data of a real molded workpiece, which is actually obtained by the respective defined molding process under consideration, in order to improve the prediction quality of the artificial neural network. Therefore, the method may also comprise a training step using prediction shape data on the one hand and real shape data of a molded workpiece on the other hand, which is actually obtained with the molding process represented by the initial shape data, material data, molding process data and tool data. In addition to the shape data of the actually obtained molded workpiece, training may comprise the use of the shape data of the mold cavity actually used.

The training of said artificial neural networks may include a learning rule typical for neural, such as Machine Learning or/and Deep Learning. The machine learning can be for example unsupervised or supervised machine learning.

The artificial neural network can, for example, be a convolutional neural network (CNN), or it can be a graph neural network (GNN). In the relevant field, the use of English terms for neural networks has also become established in German-language discussions of neural networks.

In order to obtain not only optimized prediction shape data with dimensions predicted with higher accuracy, in particular, of the molded workpiece obtained from the molding process under consideration, but also, if necessary, to bring the expected shape data of the molded workpiece closer to its nominal dimensions specified by the design, the method may advantageously comprise the following further step:

g) generating revised shape data as further optimized shape data representing a revised shape of the mold cavity of the mold tool, based on at least optimized prediction shape data determined in step f) and second initial AI data, which comprises the at least one solidification parameter and initial shape data, material data, molding process data and tool data provided in steps a), b), c), and d), by means of an electronic data processing system which is designed as an artificial neural shape optimization network trained for shape optimization.

The artificial neural shape optimization network can determine from said data, by appropriate training, revised shape data of the mold cavity, which data is used in a further or renewed run of the above-described method in its step a) as initial shape data of the mold cavity. The revised shape data of the mold cavity, with the molding process considered and represented by said data of steps b), c) and d), provide a molded workpiece whose dimensions are closer to the nominal dimensions of the desired molded workpiece than the optimized shape data obtained. Preferably, the expected shape data of a molded workpiece produced with a mold cavity with revised shape data lie within predetermined tolerance limits around the desired shape of the molded workpiece defined by the nominal dimensions.

In order to avoid unnecessary computational effort, the method may comprise the step of comparing prediction shape data of the expected molded workpiece optimized by the trained artificial neural shape optimization network with the initial shape data of the workpiece to be molded, wherein step g) is executed depending on the result of the comparison step. Thus, step g) can be omitted if the optimized shape data of the molded workpiece are sufficiently close to the nominal dimensions of the desired molded workpiece and consequently a change of the cavity shape is unnecessary.

In principle, the artificial neural simulation optimization network may use entirely different initial AI data than the artificial neural shape optimization network. However, since both artificial neural networks involve the same molding process, at least a part, preferably a major part, i.e. more than 50%, of the second initial AI data can also be first initial AI data. This greatly simplifies data management and data usage.

Further, the artificial neural simulation optimization network may be a neural network different from the artificial neural shape optimization network. Since both neural networks in the broadest sense link shape data of a mold cavity for one and the same defined molding process with shape data of a molded workpiece obtained from the molding process, the artificial neural simulation optimization network may be advantageous to the artificial neural shape optimization network.

A significant part of the creation and maintenance of the simulation model, the simulation optimization network and, if applicable, the shape optimization network will consist in the determination, provision and maintenance of the data underlying the respective model or the respective network. Since the simulation model already models the molding process in detail, including a model of the mold tool, the molded workpiece, the molded material and the molding process, the effort for data acquisition can advantageously be reduced by the fact that at least a part, preferably a major part, i.e. again more than 50%, of the initial model data is also initial AI data. The shared part of initial model data can be first or/and second initial AI data. Preferably, the electronic data processing system performing the simulation and the trained artificial neural simulation optimization network or/and the trained artificial neural shape optimization network can then retrieve their respective initial data as initial model data and initial AI data from the same data source. Along with data maintenance, this also greatly simplifies and reduces the devices required for data management.

As described above, the electronic data processing system designed to simulate the molding process preferably determines the prediction shape data by model-based simulation. In this case, a numerical model will preferably be used first and foremost. Because of the modeling of flow processes involving the flowable molded material on the one hand and processes on solids, such as heat conduction, on the other hand, one or more models may preferably be used, which are selected from a finite element numerical model, a finite volume numerical model and a finite difference numerical model, to name only the most common numerical models. The simulation can be performed on a commercially available simulation program product that runs on an electronic data processing system, such as one of the simulation program products mentioned above.

The initial shape data may comprise nominal dimensions, such as length dimensions or/and angle dimensions or/and curvature parameters, of the workpiece. The initial shape data may additionally or alternatively comprise shape data of the initial cavity. Preferably, at least a part, preferably a major part, especially preferably the entirety of the shape data is CAD data, so that it can be taken directly from the design infrastructure of a company.

To describe the materials involved in the molding process, the material data can include at least one value from density, heat capacity, thermal conductivity, in particular thermal conductivity tensor, viscosity, in particular viscosity tensor, coefficient of thermal expansion, in particular direction-dependent coefficient of thermal expansion, stiffness, in particular stiffness tensor, anisotropy coefficient, reaction kinetic coefficients and at least one characteristic material-dependent threshold value, such as softening temperature of an amorphous thermoplastic, melting temperature of a crystalline material, in particular thermoplastic material, activation temperature of a chemical process, such as a crosslinking, or glass transition temperature of an amorphous thermoplastic material, yield strength, breaking strength, of at least one component of the molded material, and the like, wherein preferably at least one value of the material data is a correlation of values of amounts of the relevant physical quantity as a function of amounts of at least one further physical quantity. Usually, the values describing the material properties will be dependent on the temperature of the respective material.

The molded material can have several components with different properties, for example as a fiber-filled or/and particle-filled thermoplastic or thermoset plastic, also thermoplastic elastomer or elastomer, in particular for injection molding, compression molding and injection compression molding. Then the material data for describing a property of the molded material can have a material unitary value describing the molded material, or the material data can have separate individual values for several components, preferably for all components. Depending on the property to be modeled in each case, the material data can have both unitary values and individual values, depending on how detailed the molded material is to be represented in terms of individual properties.

In the case of using a multicomponent molded material, in particular with flowing and non-flowing components during molding, such as a fiber- or/and particle-filled thermoplastic, the above-mentioned anisotropy coefficient can represent the anisotropy of the molded material resulting from the component mixture. The anisotropy coefficient can be a scalar, a vector, a matrix or a multidimensional tensor, as is generally the case with any value or values of the initial data.

For describing the molding process, the molding process data can have at least one value from: molding duration, molding pressure, material quantity introduced into the cavity, material temperature of the molding material at the start of the molding process, time interval between introduction of the material into the cavity and time of opening of the cavity, holding pressure, holding pressure duration, ambient temperature and the like. Here, too, preferably at least one value of the molding process data is a value correlation of amounts of the relevant physical quantity depending on amounts of at least one further physical quantity, in particular the temperature.

The tool data can have at least one value describing the tool involved in the molding process, selected from density, heat capacity, thermal conductivity, heat transfer coefficient, stiffness, in particular stiffness tensor, and thermal expansion coefficient of a material of the tool, mass of at least one tool component, density and viscosity of a coolant used in or on the tool, heat capacity of the coolant, inlet temperature of the coolant into the tool, outlet temperature of the coolant from the tool, flow velocity of the coolant, and the like. Preferably, at least one value of the tool data is a correlation of values of the relevant physical quantity depending on values of at least one further physical quantity, in particular the temperature.

The enumeration of the initial shape data, material data, molding process data and tool data is of course not complete, but depends on the level of detail of the modeling of the molding process.

The method may comprise the transmission of the prediction shape data or/and the optimized shape data or/and the further prediction shape data to an output device, such as a display screen, a printer and the like.

Under certain circumstances, in a particularly preferred variant, the method of the invention can run without determining prediction shape data according to the above-mentioned step e). Then, in addition to the aforementioned and explained steps a), b), c) and d), instead of the aforementioned step f), the aforementioned method comprises a modified step f′), in which optimized shape data are generated on the basis of first initial AI data. The first initial AI data comprises at least the at least one solidification parameter and initial shape data, material data, molding process data, and tool data provided in steps a, b), c), and d). Obviously, the first initial AI data may be the above-mentioned first initial AI data and may include data other than the above-mentioned data. Also, the modified step f is performed by means of an electronic data processing system, wherein the electronic data processing system is configured as an artificial neural shape data optimization network trained to generate optimized shape data.

For example, the method can initially comprise only steps a), b), c), d) and f) if so many simulation runs have already been performed on comparable initial data that no additional gain in knowledge can be expected from a further simulation run. In this case, the first initial AI data of the modified step f′) may have prediction shape data which, however, are not obtained by simulation but by extrapolation or/and interpolation or/and by comparable computational methods from already past simulation runs. This can considerably shorten the execution of a procedure.

Alternatively, the method can also initially comprise only steps a), b), c), d) and f) and thus take place without the prior determination of prediction shape data if the shape data optimization network of the electronic data processing system comprises a sufficiently large scope of first initial AI data and is enabled by appropriate training to generate the optimized shape data directly from the first initial AI data. The shape data optimization network will then be considerably more complex in its structure and, consequently, in its requirements for the electronic data processing system implementing it. In principle, however, it is possible to let the shape data optimization network learn a direct connection, from the initial shape data and the material data, molding process data and tool data defining the molding process on the one hand and the real final shapes of workpieces produced by molding resulting from such a molding process on the other hand. The shape data optimization network can apply this learned relationship to new initial shape data.

The above-mentioned determination of predictive shape data by simulation advantageously serves to reduce the necessary amount of training processes and to reduce the required equipment of the electronic data processing system. However, direct generation of optimized shape data from the first initial AI data as well as the at least one solidification parameter in the modified step f′) may provide an even more accurate result of optimized shape data of the mold cavity than the above combined steps e) and f).

The provision of the above-mentioned initial data, in particular the initial shape data and the tool data, enables in a particularly advantageous manner the formation of continuous process chains from optimization of the mold tool and the at least partial manufacture thereof. Therefore, in a preferred further development of the present invention, the method comprises a generation of control data for the control of at least one processing machine for the production of a mold cavity of the mold tool on the basis of the initial shape data or/and on the basis of the revised shape data, optionally also on the basis of the tool data. To provide a continuous process chain up to the production, the present method preferably also comprises a control of the at least one processing machine on the basis of the generated control data.

Such control data can be generated and provided from the shape data essentially as in a CAD/CAM process chain.

The present invention also relates to an electronic data processing device comprising the data processing device configured to simulate the molding process and the electronic data processing system configured as the trained artificial neural simulation optimization network, wherein the electronic data processing device is configured to perform the method described and further illustrated above. As has been shown above, one and the same data processing system may be formed both for simulating the molding process and as the trained artificial neural simulation optimization network. Preferably, the electronic data processing device also comprises the electronic data processing system formed as the trained artificial neural shape optimization network. Also, the latter electronic data processing system may be one and the same data processing system as the electronic data processing system formed for simulation or/and the electronic data processing system formed as the artificial neural simulation optimization network. As separately formed but data- and signal transmission-interconnected electronic data processing system, the data processing system of the electronic data processing device may be arranged and set up at different locations. Preferably, the electronic data processing device comprises an output device for outputting the prediction shape data or/and the optimized shape data or/and the further prediction shape data.

In accordance with the above-mentioned concept of a continuous process chain from tool optimization up to manufacturing of the tool or components thereof, the present invention also relates to a machine arrangement comprising at least one processing machine for shape-changing processing of a tool blank and an electronic data processing device as mentioned above. The electronic data processing device is adapted to generate control data for the at least one processing machine on the basis of the initial shape data or/and the revised shape data, optionally also on the basis of the tool data. The processing machine is designed, for example, as a numerically controllable NC machine, for example a machine tool, such as a drilling machine, milling machine and/or lathe, or an eroding processing machine, for executing a machining operation on the basis of the control data generated by the electronic data processing device.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 shows a rough schematic representation of an embodiment of an optimization system according to the invention, showing an embodiment of the machine arrangement according to the invention, in which an embodiment of the method for determining optimized shape data according to the invention is carried out.

FIG. 2 shows a rough schematic representation of initial shape data, prediction shape data, and optimized prediction shape data, and

FIG. 3 shows a rough schematic representation of revised shape data.

### DESCRIPTION OF PREFERRED EMBODIMENTS

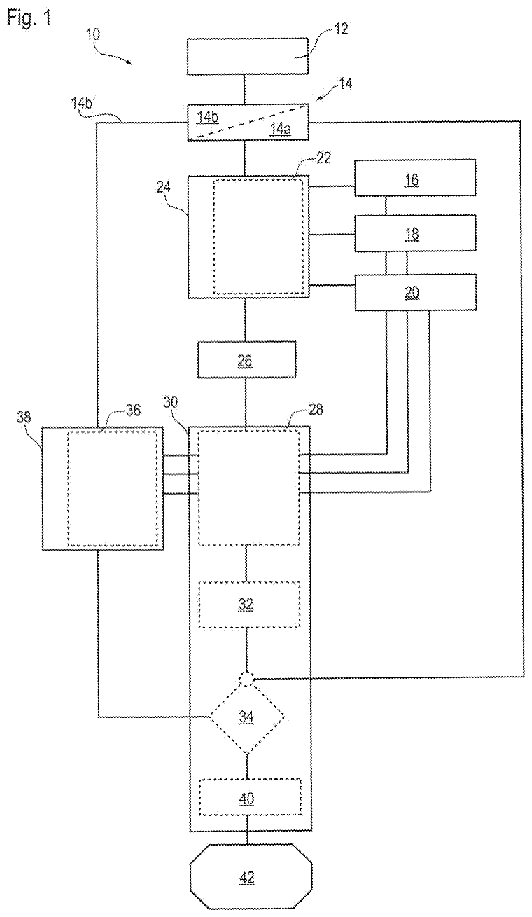

Referring now to the drawings wherein the showings are for the purpose of illustrating preferred and alternative embodiments of the invention only and not for the purpose of limiting the same, in FIG. 1, an embodiment of an optimization system according to the invention, as explained above in the introduction to the description, is generally designated with 10.

At one or more CAD workstations 12, equipped with data processing systems with CAD program products, in the course of the design of an injection-molded component triggered by a customer order, shape data 14 are developed over a period of time dependent on the complexity of the injection-molded component, namely on the one hand component shape data 14a of the injection-molded component itself and on the other hand cavity shape data 14b of the injection-mold cavity for the manufacture of the injection-molded component with the component shape data 14a.

These shape data 14 form initial shape data for the further method.

The design of the injection molded component comprises the selection of the injection molded material(s) used to produce the component, if the injection molded component is produced using a multi-component injection molding process. At least one selected injection molded material may be an injection molded material filled with fibers or/and particles to achieve increased component strength. The injection molded material itself, in pure form or as a matrix material to accommodate fibers or/and particles as filler, is preferably a thermoplastic. This can be a thermoplastic synthetic material or/and a thermoplastic elastomer. However, thermosetting plastics or/and elastomers can also be processed in molding processes of the present invention.

With the selection of the at least one injection molded material, which is referred to more generally as the molded material in the description introduction, material data 16 representing the at least one injection molded material is available. These data may include density, thermal conductivity tensor, viscosity tensor, softening temperature, melting temperature, glass transition temperature, heat capacity, surface tension, and the like. Usually, the material data will be dependent on other physical quantities, in particular temperature, which plays a special role in injection molding as a solidification parameter.

Likewise, during the design process, the molding process data 18 is preliminarily determined, such as injection speed, compression speed, volumetric flow rate, injection pressure, injection duration, injection amount, insert arrangement in the case of layers and different types of inserts and injection temperature of the injection molded material, duration and amount of holding pressure after injection of injection molded material into the cavity, closing time of the mold, time interval between the end of injection of injection molded material into the cavity and opening of the cavity, ambient temperature, cooling conditions of the mold, such as coolant flow rate, temperature of the coolant as it enters the mold, temperature of the coolant as it leaves the mold, heat transfer conditions between the mold and the coolant, and the like.

Likewise, the injection molding tool is designed together with the injection molded component and the injection mold cavity, so that tool data also accrue in the course of the design activity, such as size and mass of the molding tool, density, thermal conductivity and heat capacity of the at least one material used to manufacture the tool, number, shape and local position of sprues and tempering channels, position and shape of the mold parting surfaces and the like. In particular, material data of materials used on the molding tool may in turn be provided as a function of further physical variables, especially temperature as the decisive solidification parameter of an injection molding process.

The shape data 14, the material data 16, the molding process data 18, and the tool data 20 form initial data for a simulation program product 22 that is operatively installed and set up in a first data processing system 24. The simulation program product 22 preferably uses a numerical model to predict the flow of the flowable injection molded material in the cavity occurring during injection molding, the processes of heat transfer associated with the flow and the resulting solidification, and the subsequent cooling of the injection molded component with the thermally induced changes in dimensions that occur.

One result of the simulation of the injection molding process is predictive shape data 26 of the injection molded component, as it might be present after demolding and incomplete cooling and hardening, if applicable, given the information input into the simulation model originating from shape data 14, material data 16, molding process data 18, and tool data 20.

In practice, it has so far been shown that the accuracy of such prediction shape data 26 based only on simulation is not sufficiently accurate, due to the complexity of the processes to be simulated and of the material behavior, and due to inherent inaccuracies in the numerical modeling and the numerous calculation steps resulting therefrom, to accurately design an injection mold cavity or an injection mold tool with such an injection mold cavity on the basis of the shape data 14 originating from the design, in a fail-safe way, such that the manufactured injection tool delivers sufficiently viable injection molded components at the first attempt or with only a short run-in time. The accuracy of the predictive shape data 26 decreases significantly as the complexity of the shape of the injection molded component increases.

The consequence of these inaccuracies is a considerable amount of reworking on the injection molding tool, for example in order to provide the injection mold cavity with a shape that is pre-distorted with respect to a mere negative image of the desired injection molded component, so that the injection molded component is initially demolded with a distorted shape from the pre-distorted injection mold cavity, whereby after demolding this distorted shape is equalized during further cooling and optionally hardening by thermally and optionally thermo-mechanically or/and thermochemically induced dimensional changes and at the end of the cooling process and optional hardening process, the component's shape is sufficiently close to the desired and/or designed component shape. Unless a mere change in the process control of the injection molding process brings about a sufficient improvement, this is currently done by trial and error and requires expensive processes relative to application and removal of molded material to and from the cavity. Even changing the control of the injection molding process represents undesirable expense, since during such a “run-in” of the designed injection mold, only scrap is produced over a longer period of time.

In order to reduce this effort and to shorten the time between the design of the component and the tool, according to the method presented here, the prediction shape data 26 are input to an artificial neural simulation optimization network 28, which is specially trained for this purpose and is implemented in a second electronic data processing system 30. The simulation optimization network 28 also receives material data 16, molding process data 18 and tool data 20 to the required extent in order to generate optimized prediction shape data 32 as optimized shape data on the basis of these data.

As discussed above in the description introduction, the use of the simulation program product 22 in the first data processing system 24 to generate the predictive shape data 26 may be omitted. With quantitatively and qualitatively sufficient amounts of data available, the shape data 14, the material data 16, the molding process data 18 and the tool data 20 can be input directly into the network 28 of the second electronic data processing system 30, if the latter is appropriately trained, in order to generate the optimized shape data 32 directly from this initial data as well as from the at least one solidification parameter. Because of the omission of the processing of data obtained by simulation, the network 28 would then be a shape data optimization network 28, no longer a simulation optimization network. This is, however, only a question of most appropriate designation. Of course, it would remain a trained artificial neural network.

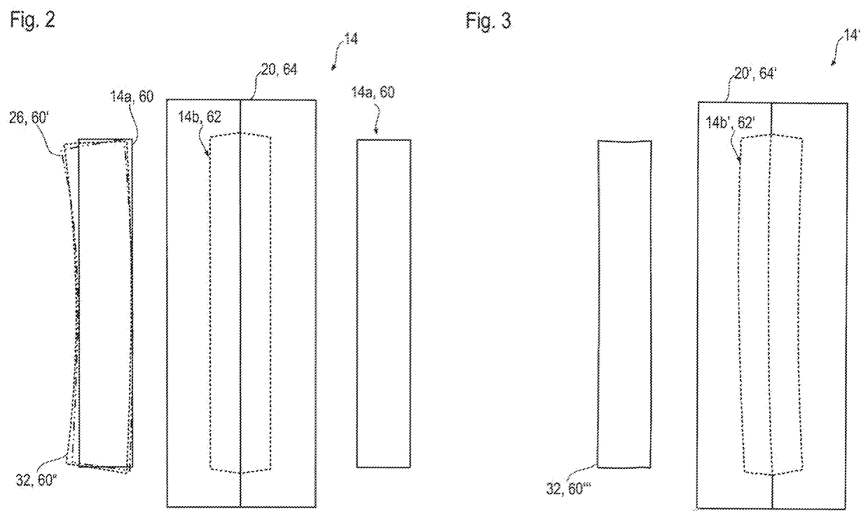

The situation after generating the optimized prediction shape data 32 using the prediction shape data 26 is shown schematically in FIG. 2.

FIG. 2 shows the initial shape data 14 graphically represented as a rough schematic virtual injection molded component 60 represented by its component shape data 14a. The injection mold cavity 62 designed with the designed injection molded component 60 is represented by its cavity shape data 14b. The injection mold cavity 62 is shown dash-lined because it is located inside an injection molding tool 64, which is represented by its tool data 20.

For clarity, the designed injection molded component 60 is shown in FIG. 2 in a stand-alone position to the right of the injection molding tool 64.

In FIG. 2, to the left of the injection mold 64, the designed virtual injection molded component 60 is again shown with a solid line as represented by its component initial shape data 14a. Superimposed on the injection molded component 60 is shown with dash-dotted line the virtual injection molded component 60′ predicted by the simulation, as represented by its prediction shape data 26. Further overlaid with dashed line is the virtual injection molded component 60″ predicted by the trained artificial neural simulation optimization network 28, as represented by the optimized prediction shape data 32. Due to shrinkage after demolding, the expected injection molded component differs from the desired designed shape, wherein the prediction accuracy of the optimized prediction shape data 32 is much higher than that of the prediction shape data 26. The shape deviations in FIG. 2 are intended to be understood qualitatively and symbolically only. They are only for illustration purposes and do not represent real shape deviations of a real existing component.

If the method were executed with omission of step e) and substitution of step f) by the modified step f′) described above, the virtual injection molded component 60′ predicted by the simulation would be omitted. The designed virtual injection molded component 60 and the predicted virtual injection molded component 60″ generated by the trained artificial shape data optimization network 28 would remain.

The optimized prediction shape data 32 may be output by the second electronic data processing system 30 for further use or may be processed internally. For example, a comparison instance 34, which is arranged in the second electronic data processing system 30 only by way of example in FIG. 1, can compare the optimized prediction shape data 32 of the injection molded component with the initial shape data 14a of the injection molded component to determine whether or not the deviations of the optimized prediction shape data 32 from the initial shape data 14a are within a predetermined tolerance range.

If the expected injection molded component deviates from the initial shape data 14a by more than the acceptable predetermined tolerance range based on its optimized prediction shape data 32, then the optimized prediction shape data 32 may be fed to a trained artificial neural shape optimization network 36 in a third electronic data processing system 38. Alternatively, the artificial neural simulation optimization network 28 may be the shape optimization network 36. Likewise, the shape optimization network 36 may be implemented in the second electronic data processing system or in the first electronic data processing system 24, in a manner different from that shown in FIG. 1.

The artificial neural shape optimization network 36, which receives not only initial shape data 14, preferably all initial shape data 14, but also material data 16, molding process data 18 and tool data 20 as initial data, generates revised shape data 14b′ of the injection mold cavity on the basis of its learned structure, which as new initial shape data 14b′ forms the basis of a renewed run for generating optimized prediction shape data 32. The artificial neural shape optimization network 36 thereby generates revised shape data 14b′ of the injection mold cavity, which results in a virtual injection molded component 60′″, the dimensions of which are expected to be less different from the initial shape 14a of the designed injection molded component. Preferably, the dimensions of the injection molded component 60′″ produced with an injection mold cavity 62′ with the revised shape data 14b′ are within the specified tolerance range. This is checked with a new process run.

Compared to FIG. 2, FIG. 3 shows the result of a new process run based on the revised shape data 14b′ as the initial shape data of the injection mold cavity 62′. The desired, designed virtual injection molded component 60 is unchanged and continues to be the target of the process. The shape of the injection mold cavity 62′ in the thus revised injection molding tool 64′ is changed based on the revised shape data 14b′ compared to the previously considered injection mold cavity 62. The resulting expected virtual injection molded component 60′″, represented by the optimized prediction shape data 32 of the injection molded part 60′″ obtained during the new process run, still does not correspond exactly to the designed and thus idealized injection molded component 60. However, its deviation from the latter in terms of shape is only so low that it can be assumed to be a good part.

If the goal of obtaining an expected injection molded component 60′″ that reproduces the desired initial shape data 14a with sufficient accuracy is achieved, the result of the comparison of the respective current optimized prediction shape data 32 of the expected injection molded component with the initial shape data 14a, which is performed by the comparison instance 34, is the recognition that the optimized prediction shape data 32 of the expected injection molded component 60′″ is within the tolerance range, whereupon the cavity shape data 14b or 14b′ which have led to the optimized predicted shape data 32 can be fed to a CAD/CAM instance 40 which, based on the cavity shape data 14b or 14b′ generates control data for at least one processing machine 42, such as a milling machine. Based on the control data generated by the CAD/CAM instance 40, the at least one processing machine 42 generates a component embodying the injection mold cavity as a tool component.

In this way, the path from a desired injection-molded component to an injection-molding process providing the desired injection-molded component with a functioning injection molding tool, and the effort required for this purpose, can be significantly reduced.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. Method for determining optimized shape data which represent a shape of a molded workpiece or/and a shape of a mold cavity of a molding tool, wherein the molded workpiece is formed from a molded material which is introduced in a flowable manner into the mold cavity as part of the molding shaping process, wherein the molded material hardens as a function of at least one solidification parameter, wherein the method comprises:
a) providing initial shape data representing an initial shape of a workpiece to be molded and/or of an initial cavity to be used for molding the workpiece,
b) providing material data representing the molded material,
c) providing molding process data representing the molding process,
d) providing tool data representing information about the tool embodying the mold cavity beyond the initial shape of the mold cavity,
e) determining predictive shape data based on initial model data comprising the at least one solidification parameter and initial shape data, material data, molding process data, and tool data provided in steps a), b), c), and d) by means of electronic data processing system by simulating the molding process,
f) generating optimized predictive shape data as the optimized shape data based on at least predictive shape data determined in step e) and based on first initial AI data comprising the at least one solidification parameter and initial shape data, material data, molding process data, and tool data provided in steps a, b, c, and d), by means of an electronic data processing system, wherein the electronic data processing system is configured as an artificial neural simulation optimization network trained to optimize predictive shape data.

17. The method according to claim 16, wherein the method comprises the following further step:
g) generating revised shape data as further optimized shape data, wherein the revised shape data represents a revised shape of the mold cavity of the molding tool, based on at least optimized predictive shape data determined in step f) and second initial AI data, which comprise the at least one solidification parameter and initial shape data, material data, molding process data and tool data provided in steps a), b), c) and d), by means of an electronic data processing system which is designed as an artificial neural shape optimization network trained for shape optimization.

18. The method according to claim 17, wherein at least a part of the second initial AI data is also first initial AI data.

19. The method according to claim 17, wherein a major part of the second initial AI data is also first initial AI data.

20. The method according to claim 17, wherein the artificial neural simulation optimization network is the artificial neural shape optimization network.

21. The method according to claim 16, wherein at least a part of the initial model data is also initial AI data.

22. The method according to claim 16, wherein a major part of the initial model data is also initial AI data, and wherein the electronic data processing system performing the simulation and the trained artificial neural simulation optimization network retrieve their respective initial data from initial model and AI data from the same data source.

23. The method according to claim 16, wherein the electronic data processing system designed for simulation of the molding process determines the prediction shape data by model-based simulation.

24. The method according to claim 16, wherein the electronic data processing system designed for simulation of the molding process determines the prediction shape data by model-based simulation using a numerical model including a numerical finite element model or/and a numerical finite volume model or/and a numerical finite difference model.

25. The method according to claim 16, wherein the initial shape data comprises nominal dimensions including length dimensions or/and angle dimensions or/and curvature parameters, of the workpiece or/and of the initial cavity.

26. The method according to claim 16, wherein the material data comprise at least one value of density, heat capacity, thermal conductivity, viscosity, thermal expansion coefficient, anisotropy coefficient and at least one characteristic material-dependent threshold value, including softening temperature, melting temperature, activation temperature or glass transition temperature, yield strength, breaking strength, of at least one component of the molded material and the like.

27. The method according to claim 16, wherein the material data comprise at least one value of density, heat capacity, thermal conductivity, viscosity, thermal expansion coefficient, anisotropy coefficient and at least one characteristic material-dependent threshold value, including softening temperature, melting temperature, activation temperature or glass transition temperature, yield strength, breaking strength, of at least one component of the molded material and the like, wherein a value of the material data is a correlation of values of the respective physical quantity depending on amounts of at least one further physical quantity.

28. The method according to claim 16, wherein the molding process data comprises at least one value of molding duration, molding pressure, amount of material introduced into the cavity, material temperature of the molding material at the beginning of the molding, time interval between introduction of the material into the cavity and time of opening of the cavity, holding pressure, holding pressure duration, ambient temperature and the like, wherein preferably the value of the molding process data is a correlation of values of amounts of the relevant physical quantity depending on amounts of at least one further physical quantity.

29. The method according to claim 16, wherein the molding process data comprises at least one value of molding duration, molding pressure, amount of material introduced into the cavity, material temperature of the molding material at the beginning of the molding, time interval between introduction of the material into the cavity and time of opening of the cavity, holding pressure, holding pressure duration, ambient temperature and the like, wherein the value of the molding process data is a correlation of values of amounts of the relevant physical quantity depending on amounts of at least one further physical quantity.

30. The method according to claim 16, wherein the tool data comprises at least one value of density of a material of the tool, heat capacity of a material of the tool, thermal conductivity of a material of the tool, thermal expansion coefficient of a material of the tool, mass of at least one tool component, at least one dimension of at least one tool component, density of a coolant used in or on the tool, heat capacity of the coolant, inlet temperature of the coolant into the tool, outlet temperature of the coolant from the tool and the like.

31. The method according to claim 16, wherein the tool data comprises at least one value of density of a material of the tool, heat capacity of a material of the tool, thermal conductivity of a material of the tool, thermal expansion coefficient of a material of the tool, mass of at least one tool component, at least one dimension of at least one tool component, density of a coolant used in or on the tool, heat capacity of the coolant, inlet temperature of the coolant into the tool, outlet temperature of the coolant from the tool and the like, wherein a value of the tool data is a correlation of values of amounts of the respective physical quantity depending on values of at least one further physical quantity.

32. The method according to claim 17, wherein the method comprises the step of comparing prediction shape data optimized by the trained artificial neural simulation optimization network with initial shape data, wherein step g) is executed depending on the result of the comparing step.

33. The method according to claim 16, wherein the method further comprises training of the artificial neural simulation optimization network using a workpiece molded based on the initial model data and using prediction shape data determined in step e).

34. The method according to claim 17, wherein the method further comprises generating control data for controlling at least one processing machine for producing a mold cavity of the molding tool on the basis of the initial shape data or/and on the basis of the revised shape data.

35. The method according to claim 17, wherein the method further comprises generating control data for controlling at least one processing machine for producing a mold cavity of the molding tool on the basis of the initial shape data or/and on the basis of the revised shape data and/or tool data, and wherein the method comprises controlling the at least one processing machine on the basis of the generated control data.

36. An electronic data processing device comprising the data processing system configured to simulate the molding process and the electronic data processing system configured as the artificial neural simulation optimization network trained for simulation optimization, wherein the electronic data processing device is configured to perform the method according to claim 16.

37. A machine arrangement comprising at least one processing machine for shape-changing processing of a tool blank and an electronic data processing device according to claim 36, wherein the electronic data processing device is adapted for generating control data operation for controlling at least one processing machine for producing a mold cavity of the molding tool on the basis of the initial shape data or/and on the basis of the revised shape data and/or tool data, wherein the processing machine is adapted to carry out a processing operation based on control data generated by the electronic data processing device.
